(19) United States
(12) Patent Application Publication
(10) Pub. No.: US 2002/0127386 A1
(43) Pub. Date: Sep. 12, 2002

(54) Thin film having porous structure and method for manufacturing porous structured materials

(76) Inventors: Miki Ogawa, Kanagawa (JP); Takashi Noma, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/061,227

(22) Filed: Feb. 4, 2002

(30) Foreign Application Priority Data
Feb. 6, 2001 (JP) 029883/2001(PAT.)

(51) Int. Cl. B01J 23/14

(52) U.S. Cl. 428/315.5; 502/352

(57) ABSTRACT

A method for manufacturing a porous structured material comprises the steps of: preparing a reactant solution that contains a metal compound and a surfactant, coating a substrate with the reactant solution, and holding the substrate in an atmosphere containing water vapor. In a thin film of an oxide having a porous structure, a surfactant is retained in the pores, and the pore walls contain tin oxide crystals.

### BACKGROUND OF THE INVENTION

1. Field of the Invention

The present invention relates to porous materials, and methods for manufacturing the same. The presenL invention also relates to a porous inorganic oxide used for catalysts, adsorbents, and the like. More specifically, the present invention relates to a mesostructured tin oxides, and methods for manufacturing the same.

2. Related Background Art

Porous materials are used in various fields, such as adsorption and separation.

It is preferable that the porous materials used as functional materials have uniform pore diameters. Recently, porous silica having a structure in which pores of a uniform diameter are arranged in a honeycomb pattern was developed at almost the same time using two different techniques.

One is a substance described in “Nature”, Vol. 359, p. 710, and specifically, it is referred to MCM-41 synthesized by hydrolyzing alkoxides of silicon in the presence of surfactants.

The other is a substance described in “Journal of Chemical Society Chemical Communications”, Vol. 1993, p. 680, and specifically, it is referred to FSM-16 synthesized by intercalating alkyl ammonium into the interlayer space of kanomite, a layered silicate.

In both methods, it is considered that the assembly of surfactant forms a template to control the structure of porous silica.

It has been known that porous silica having such a regular porous structure exhibits various macroscopic morphologies. The examples include thin films, fibers, microspheres, and monoliths.

Porous silica is expected to be used as functional materials in optical and electronic industries, as well as catalysts and adsorbents.

In recent years, there has been reported the formation of porous structured materials with various compositions such as oxides of transition metals, metals, and sulfides.

In order to accomplish a high performance as a functional material, it is preferable that the pore wall of the porous structured materials is crystallized.

Therefore, an object of the present invention is to provide a method for manufacturing a porous structured material having crystals in the pore walls. Another object of the present invention is to provide a porous structured material having crystals in the pore walls, and to provide related devices using such porous structured materials.

### SUMMARY OF THE INVENTION

According to an aspect of the present invention, there is provided a method for manufacturing a porous structured material comprising the steps of:

preparing a reactant solution that contains a metal compound and a surfactant;

coating a substrate with the reactant solution; and

holding the substrate in an atmosphere containing water vapor.

According to another aspect of the present invention, there is provided a thin film of an oxide having a porous structure, wherein a surfactant is retained in the pores, and the pore walls contain tin oxide crystals.

The present invention is mesostructured tin oxides having honeycomb porous structure (hereafter also referred to as “honeycomb”) formed using surfactants as templates, and characterized in that the pore wall contain microcrystallines of tin oxide and retains a surfactant in the micropores and that the pores retain the surfactants.

The porous structured materials of the present invention may be films having a preferentially orientated mesostructured

The thin film of the present invention may have an average diameter L (nm) of the above-described crystallites and a distance between pores M (nm), calculated using Scheller's and Bragg's equations from the diffraction peak observed in X-ray diffraction analyses satisfying the following equation (1):

1 nm≦L≦(½)M (1)

Furthermore, the thin film of the present invention may have an average diameter of the above-described crystallites of 1 to 5 nm calculated using Scheller's and Bragg's equations from the diffraction peak observed in X-ray diffraction analyses.

In addition, in the thin film of the present invention, the above-described tin oxide mesostructure may be formed on a substrate

The term “humidity” in the present specification means a relative humidity in percentage, unless giving a notice in particular. The relative humidity R (%) can be expressed in equation form as:

R=(e/E)×100,

Wherein e represents the absolute humidity (g/m³), which is an amount of water vapor actually contained in the atmosphere, and E represents an amount of saturated water vapor (g/m³) at the temperature of the atmosphere.

### BRIEF DESCRIPTION OF THE DRAWINGS

FIG. 1 is a process-flow diagram showing a method for forming a porous structure according to the present invention;

FIG. 2 is a schematic diagram showing a state of substrate holding during thin film forming according to the present invention;

FIG. 3 is a graph showing an X-ray diffraction pattern of a mesostructured tin oxide thin film according to Example 1 of the present invention;

FIG. 4 is a schematic diagram showing a plan TEM image of a mesostructured tin oxide thin film according to the present invention;

FIG. 5 is a schematic diagram showing a cross sectional TEM image of a mesostructured tin oxide thin film according to the present invention;

FIG. 6 is a graph showing an obliquely incident X-ray diffraction pattern of a tin oxide mesostructure thin film according to Example 1 of the present invention;

FIG. 7 is a graph showing an X-ray diffraction pattern of a thin film according to Comparative Example 1 of the present invention; and

FIG. 8 is a schematic diagram showing a structure of a mesostructured tin oxide according to the present invention.

### DESCRIPTION OF THE PREFERRED EMBODIMENTS

(Embodiment 1)

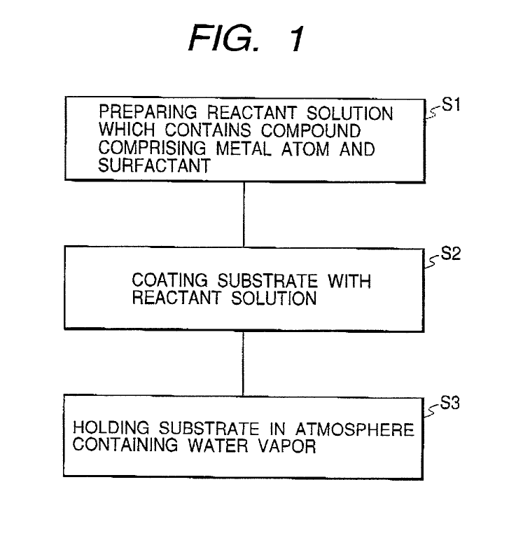

A method for manufacturing porous structured materials according to the present invention will be described below referring to FIG. 1.

First, as S1 in FIG. 1 shows, a reactant solution is prepared. The reactant solution contains a compound comprising metal atoms (hereafter referred to “metal compound”), and a surfactant.

Then, a substrate (S2) is coated with the reactant solution. Next, the substrate is held in an atmosphere containing water vapor (S3).

Through such steps, the solvent of the reactant solution which the substrate is coated with evaporates (dries), and a film having a porous structure is formed. The wording “drying” includes the meaning of the film-surface's becoming dry with holding a surfactant in the pores.

The reason why such a structure is formed is that the concentration of the surfactant exceeds the critical micelle concentration as the solvent evaporates, and self-assembly of the surfactant starts, and the self-organization of the compound containing a metal or an intermediate generated from the compound and the surfactant is promoted. Especially in the step S3, a porous structure containing crystals of an oxide comprising metal atoms (hereafter referred to “metal oxide”) in the pore walls is obtained. The porous structure in the present invention may include a surfactant in the pores.

The reactant solution contains a metal compound, a surfactant, and a solvent.

Specifically, the metals in the metal compound include Ti, Zr, Nb, Ta, Al, Si, Sn, W, and Hf.

In particular, tin oxide has been known to have properties of a semiconductor, and the application thereof to optical elements, gas sensors, or the like has been expected.

In the case when porous structured material containing the crystals of tin oxide in the pore walls is formed, a tin chlorides such as tin (II) chloride and tin (IV) chloride, or a tin alkoxide such as tin iso-propoxide and tin ethoxide can be used.

The form of the surfactant can determine the pore size and the form of porous structure.

Surfactants that can be used include, for example:

Polyoxyethylene (10) dodecylehter <C₁₂H₂₅(CH₂CH₂O)₁₀OH>,

Polyoxyethylene (10) tetradecylehter <C₁₄H₂₉(CH₂CH₂O)₁₀OH>,

Polyoxyethylene (10) hexadecylehter <C₁₆H₃₃(CH₂CH₂O)₁₀OH>, and

Polyoxyethylone (10) stearylehter <C₁₈H₃₇(CH₂CH₂O)₁₀OH>.

The pore size can be decreased with decrease in the length of alkyl chains contained in the surfactant.

In contrast, a large pore size can also be formed by using a tri-block polymer, such as HO(CH₂CH₂O)₂₀(CH₂CH(CH₃)O)₇₀(CH₂CH₂O)₂₀H.

The solvents in the reactant solution include alcohols such as methanol, ethanol, and iso-propanol (IPA). Mixed solvent of these alcohols and water can also be used. Solvents other than alcohols can also be used as long as the solvent is liquid at a normal temperature, and can dissolve the metal compounds (i.e., tin chloride). Only water, which includes no alcohol, may be used as the solvent.

It is preferable that the substrate is stable to the reactant solution, that is, the reactant solution does not, or is difficult to, react with the substrate. For example, glass, ceramics, polymers (e.g., polyimide), or metals can be used. Of course, a flexible film, such as plastic film, can be used as the substrate.

Although the coating the substrate with the reactant solution in the step S2 may be carried out in the air, it may be carried out in an atmospheric gas containing nitrogen or argon (first atmosphere).

The step S2 may be carried out in an oxidizing atmosphere and a reducing atmosphere containing hydrogen and so forth.

The temperature of the atmosphere where the substrate is placed during the coating the substrate with the reactant solution (first temperature) may be a room temperature of course (e.g. 15° C. to 35° C.), but is preferably a temperature between 0° C. and 50° C.

The humidity during the coating the substrate with the reactant solution may be within the range of 0% to 80%. However, after the step S2, it is preferable to start the step S3 after the reactant solution (especially the solvent) on the substrate is once dried up. That is, the step S2 is followed by the drying step such as drying the solvent at a temperature of 35° C. to 50° C. and in a humidity of 10% to 30%, and then the step S3 is carried out.

Of course, the step S2 itself may be carried out in an atmosphere containing water vapor.

A method for coating the substrate with the reactant solution will be described.

As a coating method that can be carried out easily in a short time, the casting method is effective.

If it is desired to coat the substrate with the reactant solution evenly, or it is desired to control the film thickness accurately, the dip coating method is effective. This is a method for coating the substrate with the liquid evenly by dipping a substrate in the reactant solution, and lifting it up at a constant speed. The quantity of liquid which the substrate is coated with, that is, the thickness of the formed thin film can be controlled, for example, by the lifting speed. A higher lifting speed forms a thicker film; and a lower lifting speed forms a thinner film.

Furthermore, when the formation of a uniform and thin film is desired, the spin coating method is effective. This is a method for coating the substrate with the reactant solution evenly by dropping the liquid onto the substrate, and rotating the substrate. The quantity of reactant solution which the substrate is coated with, that is, the thickness of the formed thin film can be controlled by the speed of rotation of the substrate. A higher rotation speed forms a thinner film; and a lower rotation speed forms a thicker film.

Other methods can also be used in the present invention if the method can coat the substrate with the reactant solution, such as the spray coating method suitable for mass production.

The atmosphere containing water vapor (second atmosphere) in the step S3 is a saturated water vapor atmosphere, or an atmosphere having humidity of 40% to 100%, and preferably 60% to 100%, and more preferably 70% to 90%. The above-described first atmosphere may be an atmosphere containing water vapor. The humidity in the first and second atmospheres can be changed. Where denoting temperature, relative humidity and absolute humidity of the first atmosphere in the step S2 by T_{S2}, R_{S2} and e_{S2} respectively; temperature, relative humidity and absolute humidity of the second atmosphere in the step S3 by T_{S3}, R_{S3} and e_{S3}, respectively; and saturated vapor pressures at the temperatures in the steps by E(T_{S2}) and E(T_{S3}), respectively, the relation of e_{S2}<e_{S3} is preferable for the present invention. The following are applicable ranges of R_{S2} and R_{S3}:

R_{S2}=0% to 80% (T_{S2}=0° C. to 50° C.)

R_{S3}=40% to 100% (T_{S3}=15° C. to 100° C.)

The temperature of the atmosphere in the step S3 (second temperature) is 15° C. or above and 100° C. or below; preferably, between 25° C. and 60° C. The second temperature is preferably higher than the above-described first temperature. For example, a room temperature of 25° C. can be selected as the first temperature, and 40° C. can be selected as the second temperature.

By carrying out the step S3 at a low temperature of 15° C. to 100° C., porous structured material containing the crystals of a metal oxide in the pore walls can be obtained in the state where the surfactant is contained in the pore. Particularly speaking, holding a surfactant in pores is available for a strength of the porous structure A surfactant having previously a functionality may be used. Further, it is permissible to make a surfactant and a functional material coexist in the reactant solution. The wording “function” hereupon means such a function as exhibiting a conductivity by the irradiation with light.

The time for holding a substrate in the step S3 can be between several hours and several hundred hours. It is better to carry out the step S3 in gaseous phase but not liquid one, even if the step should be carried out in a humidity of 100%.

Through the stops S1 to S3 as described above, the reactant solution on the substrate is dried up, and a porous structure of a metal oxide is formed on the substrate. Here, a thin film of a porous structure is formed on the substrate.

According to IUPAC (International Union of Pure and Applied Chemistry), porous materials are classified into microporous structures having pore size of 2 nm or less, mesoporous structures having pore size from 2 nm to 50 nm, and macroporous structures having pore size of 50 nm or more

In the present invention, since pore size can be changed as desired by the types of surfactants as described above, any of these classified porous structures are included. The present invention is expected particularly for forming mesoporous structures having pore size larger than the pore size of microporous structures.

Zeolites, such as natural and synthetic aluminosilicates, and metal phosphates have been known as microporous materials. These are used for selective adsorption, form selective catalytic reaction, or reaction vessels of molecular sizes utilizing the sizes of micropores.

A mesostructured tin oxide is especially promising among mesostructured materials. The formation of the structure will be described below in detail.

In the reactant solution which the substrate is coated with by the above-described coating method (S2), as the solvent evaporates, the concentration of the surfactant exceeds the micelle concentration, self-assembly of the surfactant begins, and self-organization of tin compound or intermediates formed from tin compound and surfactants is accelerated. That is, the aggregate of the surfactant forms micelles to become the template of pores, and a honeycomb structure is formed. If this forming process is carried out in an atmosphere containing water vapor (S3), the improvement of regularity of the mesostructure is significantly accelerated Water is provided gradually for the film so that the hydrolysis or condensation of the tin compound or the intermediate from tin compound is promoted, whereby the crystallization of the walls of micropores is promoted.

When the temperature is low in the step S3, the pore walls can be crystallized while maintaining the high regularity of the mesostructure. Although complete crystallization is preferred, the pore walls may be polycrystalline or microcrystalline as long as desired functions can be exerted.

Although calcination at a temperature as high as 400° C. is reported in “Nature”, Vol. 396, p. 152 (1998) as a method for crystallizing, calcination as such a high temperature is not preferable, because themesostructure may be disturbed. Therefore, in the method of the present invention, the temperature in the step S3 is preferably 100° C. or below, and specifically, it may be a low temperature as low as 40° C.

Although the atmosphere containing water vapor is preferably the atmosphere in the reaction vessel wherein water vapor is saturated at the above-described temperature, the regularity of the mesostructure can be improved, and the pore walls can be crystallized by increasing the holding time even in the atmosphere having a relative humidity is 40% or over but less than 100%.

If all the steps are carried out at the temperature below that for removing the surfactant, porous structured materials having crystallized pore walls can be provided as the mesostructured materials holding the surfactants which are templates of pores.

Of course, the surfactant can be removed after pore walls have been crystallized. The examples of the means of removing the surfactant follow: calcination, irradiation with ultraviolet light, oxidizable decomposition by ozone, extraction by supercritical fluid, and extraction by solvent.

(Embodiment 2)

Next, the porous structured material according to the present invention is specifically characterized to be a thin film having a porous structure of a honeycomb structure that holds a surfactant in the pores, and contains the crystals of an oxide in the pore walls. The porous structure is formed of the oxide of at least a metal, for example, tin oxide. Here, crystals include single crystals, polycrystals, and microcrystallites.

The holding of the surfactant in the pores makes it possible to maintain the mechanical strength in comparison with a case where the surfactant is removed.

A porous structured material according to the present invention is characterized in that especially a mesostructured tin oxide has highly structural ordering and forms crystalized pore walls.

In order to make highly structural ordering and crystalized pore walls compatible, it is preferable that the average size of tin oxide microcrystallites is equal to or smaller than the thickness of pore walls.

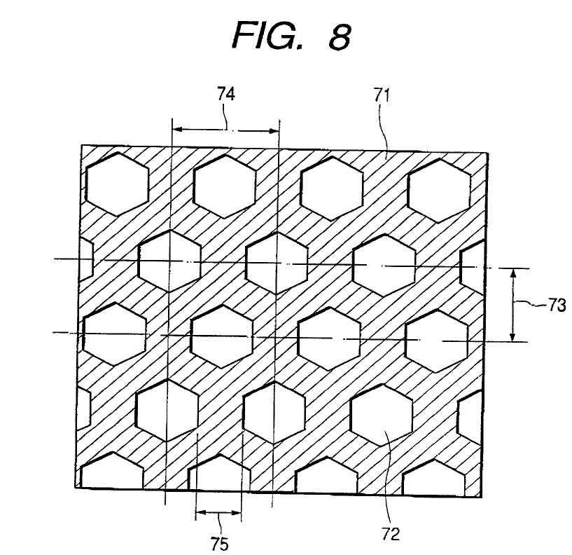

In general, the thickness of pore walls La (75 in FIG. 8) is considered to be about ½ the distance between pores M (nm) (74 in FIG. 8) estimated from X-ray diffraction analysis or smaller. In FIG. 8, reference numerals 71 and 72 denote a pore wall and a pore, respectively.

The distance between pores M (nm) can be calculated from the following equation (2) using the lattice distance d₁₀₀ (nm) (73 in FIG. 8) of the mesostructure obtained by X-ray diffraction analysis.

M=(2×\sqrt{3})d₁₀₀ (2)

The lattice distance d₁₀₀ (nm) of the mesostructure can be calculated from the following equation (3) using the peak diffraction angle 2θ observed in X-ray diffraction analysis on the basis of Bragg's law.

d₁₀₀=λ/2 sin θ (3)

Here, λ (nm) is the wavelength of X-ray, and CuKα is used for the beam source in the present invention.

Therefore, it is preferable that the average size of crystallite L (nm) satisfies the following formula (1)

1 nm≦L≦(½)M (1)

Specifically, it is preferable that the average size of crystallite L (nm) is 1 to 10 nm, more preferably 1 to 5 nm.

(Embodiment 3)

Various devices to which the porous structured material shown in above embodiments is applied will be described.

Examples of the applications of the porous structured material include a filter selecting or adsorbing various materials and a gas sensor

### EXAMPLES

The present invention will be described below in further detail referring to examples; however, the present invention is not limited to these examples, but the materials, reaction conditions, and the like can be modified freely as long as a mesostructured tin oxide having the similar structure can be obtained.

### Example 1

First, the surface of a glass substrate was washed with isopropyl alcohol and pure water, and cleaned by UV radiation in an ozone generator.

Next, 2.0 g of Polyoxyethylene (10) stearylether <C₁₈H₃₇(CH₂CH₂O)₁₀OH> was dissolved in 20 g. of ethanol, the mixture was stirred for 30 minutes, 5.2 g of tin (IV) chloride anhydride was added, and the mixture was stirred for further 30 minutes to form a reactant solution. These operations were carried out in a nitrogen atmosphere.

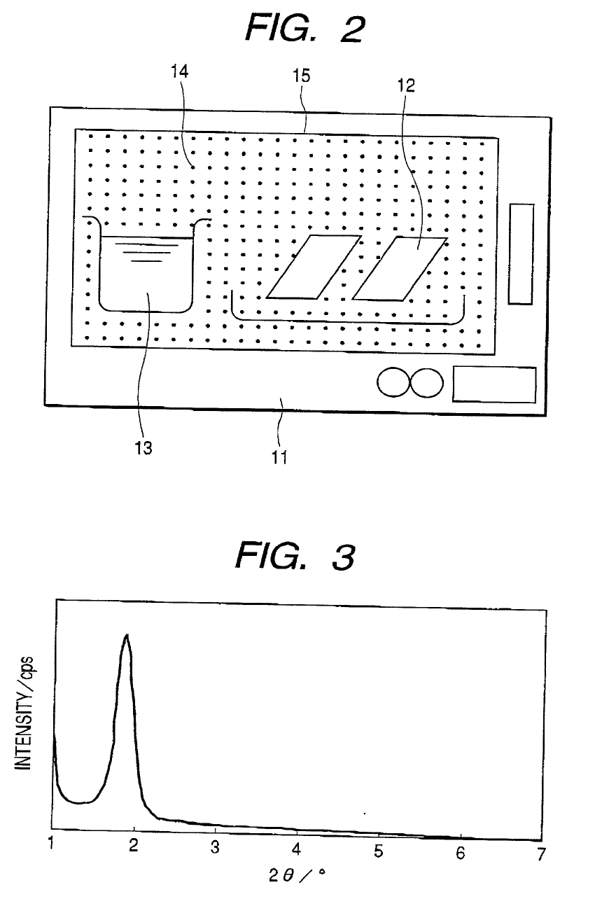

Thereafter, the reactant solution was placed in the air, and the substrate was coated with this reactant solution by the casting method. The substrate coated with this reactant solution was placed in the air at 40° C. for 7 days to form a thin film on the substrate. In the 40° C. atmosphere, as FIG. 2 shows, the substrate 12 was placed in the reaction vessel 15 of the dryer 11 together with water 13, and substantially saturated water vapor 14 was produced.

The thin film formed on the substrate using the above-described method was uniform without cracks, and was transparent.

The X-ray diffraction analysis of the thin film was conducted, and a strong diffraction peak which corresponds to the lattice distance of 4.8 nm was observed as FIG. 2 shows, which proved that the thin film had mesostructure.

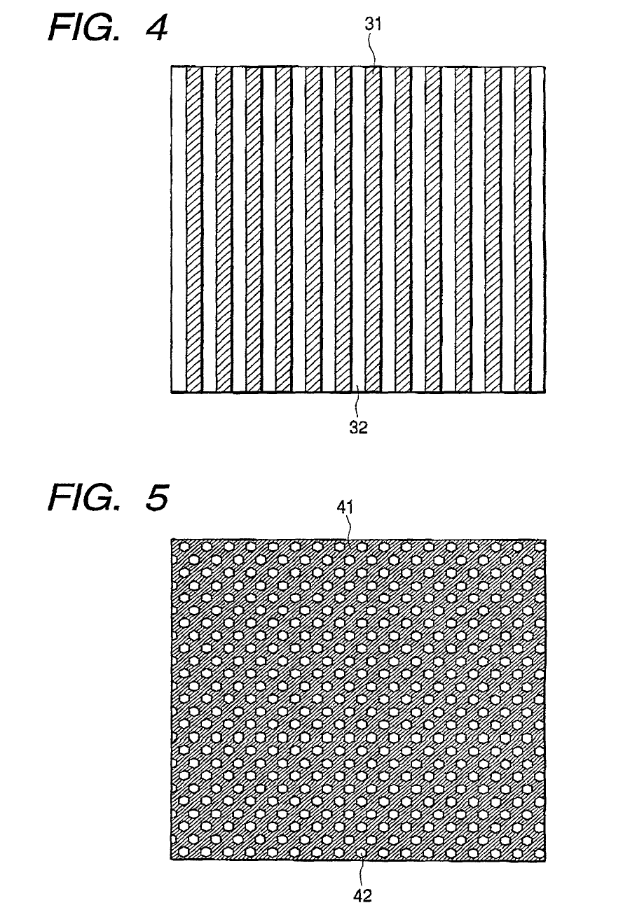

Next, observation using a transmission electron microscope was performed, and tubular pores 32 were observed on the surface of the film as FIG. 4 shows. In the cross sectional view of the film shown in FIG. 5, it was confirmed that pores 42 of a honeycomb structure were formed on the entire film. In other words, it was confirmed that all the tubular pores on the entire film were formed in parallel to the substrate, and that the porous structure was preferentially oriented. Reference numerals 31 and 41 in FIGS. 4 and 5 denote a mesostructured tin oxide. However, since this structure was a little vertically contracted, it did not exactly agreed with the hexagonal structure heretofore reported

Next, an electron-beam diffraction analysis was conducted on the thin film, particularly in the region where a highly ordered mesostructure was observed by the transmission electron microscope, and a pattern substantially coincident to the diffraction pattern of cassiterite, SnO₂ was obtained. During observation, electron beams destroyed no mesostructured material.

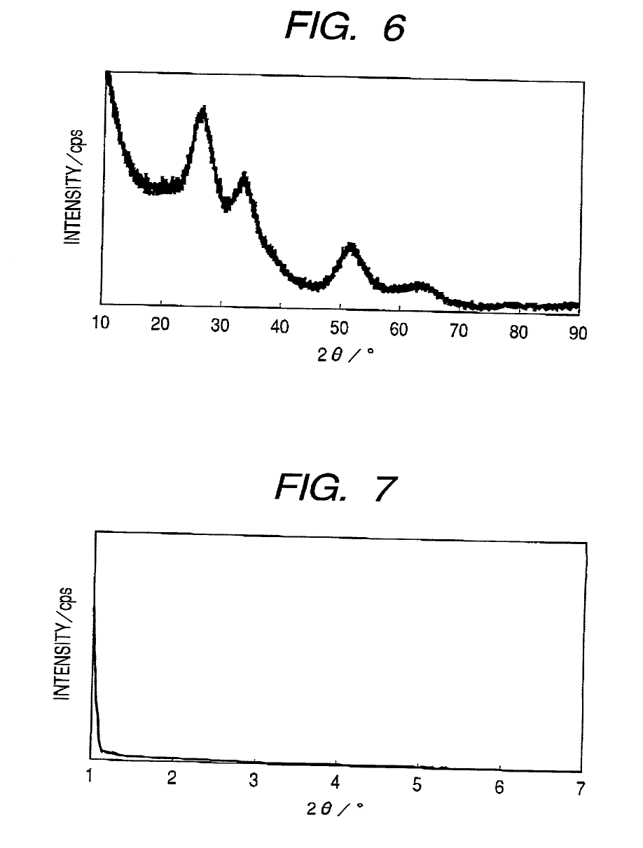

In grazing incident in-plane X-ray diffraction analysis, distinct peaks were observed at 20=26.6°, 33.9°, 51.7°, and 65.8°, which attribute to cassiterite, SnO₂ as FIG. 6 shows. This suggests that microcrystallites have grown in the pore walls while the mesostructure is retained.

Also, the full-width-at-half-maximum of the diffraction Profile B (rad) and the diffraction angle 2θ of the peak were measured in the region of 2θ=21° to 31°, and the average size of crystallite L was determined by the Scheller's method. The result was 2.2 nm. The Scheller's formula is as follows:

L=0.9 Å/B cos θ (6)

From these results, it was confirmed that the continuous and highly uniform thin film of a mesostructured tin oxide having a highly ordered porous structure and crystallized pore walls were obtained according to the present invention.

A same mesoporous structure as the above was obtained under the same condition as in the above example except for using a reactant solution prepared with polyoxyethylene (20) cetylether <C₁₆H₃₃(CH₂CH₂O)₂₀OH> as the surfactant and water containing no alcohol as the solvent.

### Example 2

Similar to the Example 1, the surface of a b glass substrate was washed with isopropyl alcohol and pure water, and cleaned by UV radiation in an ozone generator.

Next, 2.0 g of triblock copolymer <HO(CH₂CH₂O)₂₀(CH₂CH(CH₃)O)₇₀(CH₂CH₂O)₂₀H> was dissolved in 20 g of ethanol, the mixture was stirred for 30 minutes, 5.2 g. of tin (IV) chloride anhydride was added, and the mixture was stirred for further 30 minutes to form a reactant solution. These operations were carried out in a nitrogen atmosphere.

Thereafter, the reactant solution was placed in the air, and the glass substrate was coated with the reactant solution by the dip coating method. The lifting speed in the dip coating method was 3.5 mm/s.

The substrate coated with the reactant solution was placed in the air at 40° C. for 7 days to form a thin film on the substrate. In the 40° C. atmosphere, as FIG. 2 shows, water was made to coexist, and substantially saturated water vapor was produced.

The thin film formed on the substrate using the above-described method was uniform without cracks, and was transparent.

The X-ray diffraction analysis of the thin film was conducted, and a strong diffraction peak which corresponds to the lattice distance of 11.6 nm was observed, which proved that the thin film had mesostructure.

Next, observation using a transmission electron microscope was performed, and tubular micropores were observed on the surface of the film as FIG. 4 shows. In the cross sectional view of the film shown in FIG. 5, it was confirmed that pores of a honeycomb structure were formed on the entire film. In other words, it was confirmed that all the tubular pores on the entire film were formed in parallel to the substrate, and that the mesostructure was preferentially oriented. However, since this structure was a little vertically contracted, it did not exactly agreed with the hexagonal structure heretofore reported.

Next, an electron-beam diffraction analysis was conducted on the thin films particularly in the region where a highly ordered mesostructure was observed by the transmission electron microscope, and a pattern substantially coincident to the diffraction pattern of cassiterite, SnO₂ was obtained. During observation, electron beams destroyed no mesostructured material.

In grazing incident in-plane X-ray diffraction analysis, distinct peaks were observed at 2θ=26.6°, 33.9°, 51.8° and 65.9°, which attribute to cassiterite, SnO₂. This suggests that crystallites have grown in the pore walls while the mesostructure is retained.

Also, the full-width-at-half-maximumum of the diffraction profile R (rad) and the diffraction angle 2θ of the peak were measured in the region of 20=21° to 31°, and the average size of crystallite L was determined by the Scheller's method. The result was 3.4 nm.

From these results, it was confirmed that the continuous and highly uniform thin film of mesostructured tin oxide having a highly ordered porous structure and crystallized pore walls were obtained according to the present invention.

### Example 3

First, the surface of a glass substrate was washed with isopropyl alcohol and pure water, and cleaned by UV radiation in an ozone generator

Next, 2.0 g of Polyoxyethylene (10) stearylehter <C₁₈H₃₇(CH₂CH₂O)₁₀OH> was dissolved in 20 g of ethanol, the mixture was stirred for 30 minutes, 5.2 g of tin (IV) chloride anhydride was added, and the mixture was stirred for further 30 minutes to form a reactant solution. These operations were carried out in a nitrogen atmosphere.

Thereafter, the reactant solution was placed in the air, and the glass substrate was coated with the reactant solution using the spin coating method. The rotation speed in the spin coating method was 1,000 rpm, and coating was continued for 20 seconds.

The substrate coated with the reactant solution was placed in the air at 40° C. for 7 days to form a thin film on the substrate. In the 40° C. atmosphere, as FIG. 2 shows, water was made to coexist, and water vapor of a substantially saturated state was produced.

The thin film formed on the substrate using the above-described method was uniform without cracks, and was transparent.

The X-ray diffraction analysis of the thin film was conducted, and a strong diffraction peak was observed at a plane distance of 4.9 nm, which proved that the thin film had a mesostructure.

Next, observation using a transmission electron microscope was performed, and tubular micropores were observed on the surface of the film as FIG. 4 shows. In the sectional view of the film shown in FIG. 5, it was confirmed that micropores of a honeycomb structure were formed on the entire film. In other words, it was confirmed that all the tubular micropores on the entire film were formed in parallel to the substrate, and that the mesostructure was selectively oriented. However, since this structure was a little laterally strained, it did not exactly agreed with the hexagonal structure heretofore reported.

Next, all electron-beam diffraction analysis was conducted on the thin film, particularly in the region where a highly regular mesostructure was observed by the transmission electron microscope, and a pattern substantially coincident to the diffraction pattern of cassiterite, SnO₂ was obtained. During observation, electron beams destroyed no mesostructure.

In obliquely incident X-ray diffraction analysis, distinct peaks were observed at 2θ=26.5°, 33.8°, 51.7°, and 65.9°, which attribute to cassiterite, SnO₂. This suggests that crystallites have grown in the pore walls while the mesostructure is retained.

Also, the full-width-at-half-maximum of the diffraction profile B (rad) and the diffraction angle 2θ of the peak were measured in the region of 2θ=21° to 31°, and the average crystallite diameter L was determined by the Scheller's method. The result was 2.1 nm.

From these results, it was confirmed that the continuous and highly uniform thin film of a tin oxide mesostructure having a highly regular porous structure and crystallized pore walls were obtained according to the present invention.

### Comparative Example 1

Next, a Comparative Example wherein after coating a substrate with reactant solution, the substrate was held in the air at 40° C. without coexistence of water, will be described below.

Similar to the Example 1, the surface of a glass substrate was washed with isopropyl alcohol and pure water, and cleaned by UV radiation in an ozone generator.

Next, 2.0 g of Polyoxyethylene (10) stearylehter <C₁₈H₃₇(CH₂CH₂O)₁₀OH> was dissolved in 20 g of ethanol, the mixture was stirred for 30 minutes, 5.2 g of tin (IV) chloride anhydride was added, and the mixture was stirred for further 30 minutes to form a reactant solution. These operations were carried out in a nitrogen atmosphere.

Thereafter, the reactant solution was placed in the air, and the glass substrate was coated with the reactant solution by the casting method.

The substrate coated with the reactant solution was placed in the air at 40° C. for 7 days to form a thin film on the substrate. The thin film formed on the above-described method was white and opaque.

The X-ray diffraction analysis of the thin film was conducted, but no distinct diffraction peaks were observed as shown in FIG. 7, and a mesostructure having ordered structure could not formed.

### Example 4

A glass substrate was coated with the same reaction liquid as in Example 1 at room temperature and in a relative humidity of 40%. Then, the glass substrate was held at temperature of 40° C. and in a relative humidity of 80% for 230 hours in an environmental testing vessel, whereby a porous structure was formed on the substrate. According to an X-ray analysis, an intensive peak was observed at an lattice distance of 4.6 nm of the resultant, whereby it was determined that the structure has a mesostructure. The average size of crystallite was 2.2 nm.

What is claimed is:

1. A method for manufacturing a porous structured material comprising the steps of:
preparing a reactant solution that contains a metal compound and a surfactant;
coating a substrate with the reactant solution; and
holding the substrate in an atmosphere containing water vapor.

2. The method for manufacturing a porous structured material according to claim 1, wherein said metal compound in said reactant solution is a tin compound, and said porous structured material comprises an oxide of tin.

3. The method for manufacturing a porous structured material according to claim 1, wherein said step of holding said substrate in an atmosphere containing water vapor is performed at a temperature of 100° C. or less.

4. The method for manufacturing a porous structured material according to claim 2, wherein said tin compound is a tin chloride.

5. The method for manufacturing a porous structured material according to claim 1, wherein said reactant solution contains an alcohol.

6. The method for manufacturing a porous structured material according to claim 1, wherein the coating said substrate with said reactant solution is performed by casting method, dip coating method, or spin coating method.

7. The method for manufacturing a porous structured material according to any one of claims 1 to 6, wherein the relative humidity of said atmosphere containing water vapor is within the range of 40% to 100%.

8. The method for manufacturing a porous structured material according to any one of claims 1 to 6, wherein the absolute humidity in said holding step is greater than that in said applying step.

9. The method for manufacturing porous structured material according to claim 1, wherein said reactant solution contains water but does not contain any alcohol.

10. The method for manufacturing a porous structured material according to any one of claims 1 to 6, wherein pores of said porous structured material are mesopores with the size from 2 nm to 50 nm.

11. A thin film of an oxide having a porous structure, wherein a surfactant is retained in the pores, and the pore walls contain tin oxide crystals.

12. The thin film according to claim 11, wherein said porous structure is a film having a mesostructure and a preferred orientation.

13. The thin film according to claim 11, wherein an average crystallite size L (nm) and a distance between pores M (nm) of said crystal, calculated using Scheller's equation and Bragg's equation from the diffraction peak observed in X-ray diffraction analyses satisfy the following formula:
1 nm≦L≦(½)M

14. The thin film according to claim 11, wherein an average crystallite diameter L (nm) of said crystal, calculated using Scheller's equation and Bragg's equation from the diffraction peak observed in X-ray diffraction analyses is 1 to 5 nm.

15. The thin film according to claim 13, wherein said average crystallite diameter L (nm) is 1 to 5 nm.

16. The method for manufacturing porous structured material according to claim 1, wherein said surfactant is nonionic surfactant.

17. The method for manufacturing porous structured material according to claim 16, wherein said nonionic surfactant is polyoxyethylene ether containing ethylene oxide group as hydrophilic group and alkyl group as hydrophobic group.

18. The thin film according to any one of claims 11 to 15, wherein said microporous structure is formed on a substrate.
